(19) United States
(12) Patent Application Publication
(10) Pub. No.: US 2022/0075749 A1
(43) Pub. Date: Mar. 10, 2022

(54) SYSTEMS AND METHODS FOR DYNAMIC CONFIGURATION OF EXTERNAL DEVICES

(71) Applicant: NEMEDIO INC., Brooklyn, NY (US)

(72) Inventors: Sabrina VARANELLI, New York, NY (US); Kevin STALLARD, Cove, UT (US)

(73) Assignee: NEMEDIO INC., Brooklyn, NY (US)

(21) Appl. No.: 17/466,398

(22) Filed: Sep. 3, 2021

Related U.S. Application Data
(60) Provisional application No. 63/074,733, filed on Sep. 4, 2020.
(60) Provisional application No. 63/074,736, filed on Sep. 4, 2020.
(60) Provisional application No. 63/074,739, filed on Sep. 4, 2020.

(51) Int. Cl. G06F 13/40; G06F 11/07; G06F 11/30; G06F 13/38

(52) U.S. Cl. CPC G06F 13/4072; G06F 13/385; G06F 11/3013; G06F 11/0775

(57) ABSTRACT

A computer-implemented method includes connecting a target system to a development system via an application and connecting an external device to an interface of the target system. The method also includes obtaining information about the target system and transmitting the information to the development system and instructing initiation of a driver associated with the interface based on a command received from the development system. The method further includes receiving a command to define and store a communications bus associated with the driver from the development system, receiving information about the external device from the development system, and associating the information about external device with the communications bus.

### CROSS-REFERENCE TO RELATED APPLICATION

This application claims the benefit of priority under 35 U.S.C. § 119(e) to prior U.S. Provisional Application No. 63/074,733, filed Sep. 4, 2020, prior U.S. Provisional Application No. 63/074,736, filed Sep. 4, 2020, and prior U.S. Provisional Application No. 63/074,739, filed Sep. 4, 2020, the disclosures of which are incorporated by reference herein to their entirety.

### TECHNICAL FIELD

Disclosed embodiments generally relate to communication between computing systems and other devices, and, in particular to dynamic generation of message structures or message formats and the messages themselves based on high level message descriptions for communication with external devices such as actuators and sensors.

### BACKGROUND

Interfacing purpose-built computer systems with the physical world with sensors (external signals) and actuators (external devices) traditionally requires a significant amount of custom software engineering. Typically, over 80% of the software development work of a purpose-built embedded system is interfacing with signals external to the system.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The embodiments described herein are directed to a computer-implemented method that includes connecting a target system to a development system via an application and connecting an external device to an interface of the target system. The method also includes obtaining information about the target system and transmitting the information to the development system and instructing initiation of a driver associated with the interface based on a command received from the development system. The method further includes receiving a command to define and store a communications bus associated with the driver from the development system, receiving information about the external device from the development system, and associating the information about external device with the communications bus.

In further aspects, the method includes using the information to generate messages at runtime to communicate with the external device.

In further aspects, the generated messages include a header, a body, and error correction data, and wherein the header, the body, and the error correction data are described by message elements including data items describing a type and a length of the data contained by the header, the body, or the error correction data.

In further aspects, the method includes testing the external device based on a command received from the development system.

In further aspects, the external device is an actuator.

In further aspects, the external device is a sensor.

In further aspects, the method includes, in response to receiving an interrogate command, transmitting a set of information indicating a set of external devices connected to the target system.

In further aspects, the method includes, in response to receiving a define communications bus command, associating a low level driver with an identified communication bus.

The embodiments described herein are directed to a system that includes a development system, a target system configured to connect to the development system via an application, and an external device configured to connect to an interface of the target system. The development system is configured to obtain information about the target system and transmit a command instructing an initiation of a driver associated with the interface. The development system is configured to transmit a command to define and store a communications bus associated with the driver, transmit information about the external device, and associate the information about the external device with the communications bus.

The embodiments described herein are directed to a non-transitory computer readable medium having instructions stored thereon, wherein the instructions, when executed by at least one processor, cause a device to perform operations that include connecting a target system to a development system via an application and connecting an external device to an interface of the target system. The operations include obtaining information about the target system and transmitting the information to the development system and instructing initiation of a driver associated with the interface based on a command received from the development system. The operations include receiving a command to define and store a communications bus associated with the driver from the development system, receiving information about the external device from the development system, and associating the information about external device with the communications bus.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The features and advantages of the present disclosures will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 is a block diagram of an example purpose-built computing system in accordance with some embodiments;

FIG. 2 is a block diagram of an example computing device in accordance with some embodiments;

FIG. 3 is a block diagram illustrating an example of a target computer system in accordance with some embodiments;

FIG. 4 is a block diagram illustrating an example a development computer system in accordance with some embodiments;

FIG. 5 is a block diagram illustrating example communication between a development computer system and a target computer system;

FIG. 6 is a diagram showing an example of one or more processes that may be completed with respect to the target computing system through the development interface;

FIG. 7 is a depiction of an entity relationship diagram describing the parts of a wire protocol definition;

FIG. 8 is a diagram of an example data structure of application interfaces;

FIG. 9 is a diagram of the structure of the part of the system that handles communication with devices;

FIG. 10 is a flow diagram depicting data arriving. As data in the message is recognized, the data is moved into the respective properties;

FIG. 11 is a diagram of an exemplary embodiment of a process manager; and

FIG. 12 is a diagram of an exemplary digital signal processing system. Disclosed embodiments relate to dynamic digital signal processing.

In the drawings, reference numbers may be reused to identify similar and/or identical elements.

### DETAILED DESCRIPTION

This description of the exemplary embodiments is intended to be read in connection with the accompanying drawings, which are to be considered part of the entire written description.

The exemplary embodiments are described with respect to the claimed systems as well as with respect to the claimed methods. Features, advantages, or alternative embodiments herein can be assigned to the other claimed objects and vice versa. For example, claims for the providing systems can be improved with features described or claimed in the context of the methods, and vice versa. In addition, the functional features of described or claimed methods are embodied by objective units of a providing system.

Disclosed embodiments include systems and methods for providing communication between computing systems and other devices, including peripheral devices such as sensors and actuators. Disclosed embodiments can include features that eliminate the need to complete software development when introducing sensors and actuators into a purpose or custom built computing system. Disclosed embodiments can achieve these and other benefits by, for example, providing a developer interface that permits the discovery of existing hardware and communication components in the system; providing a developer interface to specify the devices that are connected to the communication components in the system; providing a developer interface that allows the definition of the ‘wire protocol’ needed to communicate with the device, allowing the capture of the full capability of any external device; providing a developer interface allowing the definition of how the data is processed before it gets to the application; providing a developer interface allowing the definition of how outgoing and incoming data are handled (scheduled, fire events/notifications, polled, etc.); allowing hardware settings to be specified; allowing the developer to test communication to external devices; providing an API for applications to easily connect to, configure, and read or write to external devices; etc.

The data sent to these developer interfaces to configure and define communication protocols can be saved and stored so they are available when the system is activated.

Some existing software packages (e.g., LabView) have to have external devices that have already been qualified to work with the system. The communications interfaces are “hard coded” and new devices that have not been made to interface with the system cannot work.

Disclosed systems provide the means of creating connections to external devices and signals without having to do the complex software development that has traditionally been required to ensure compatibility. The presently disclosed system also provides the means of adopting devices and signals that have not been previously defined and qualified. It allows any device that can be communicated with to be incorporated with the system under development without writing software to make it work.

After these external devices have been defined, it provides the means for the system application to easily leverage the capability of sensors and actuators without complex software development.

It also has a provision to allow the message structure to become permanent. It can cause source code to be generated. This will make the configuration an integral part of the software. This is for systems where there is concern about data corruption in the storage device or where accessing the storage device for configuration is not allowed.

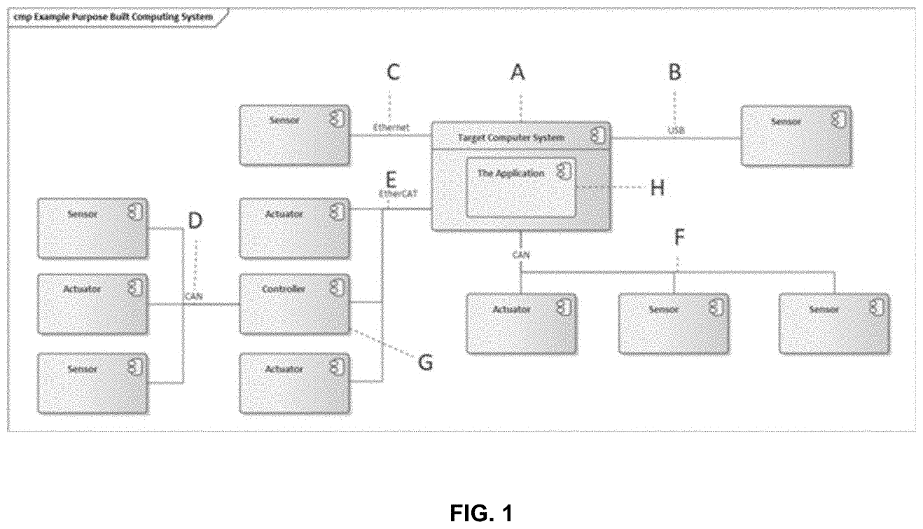

FIG. 1 illustrates the architecture of an example of a purpose-built computing system. The Target Computer System (A) is connected via communications busses (B, C, D, E and F) to actuators, sensors or other purpose built computing systems (a controller in this case (G)). The Application (H) utilizes the data from sensors and sends data to actuators. It has to have a way to acquire and send data as needed.

Many communication busses are involved because engineers may be trying to save cost by not building their own actuators and sensors. Many sensors and actuators are self-contained and are manufactured with the ability to communicate on an industry standard communications bus. Not all sensor and actuators use the same kind of communications bus.

In order for the Application to utilize these actuators and sensors (as well as custom or purpose-built actuators and sensors), developers have to write software to communicate with them. As mentioned above, this can consume a majority of the software development effort and often requires developers with specialized knowledge in order to do so.

The reason for this is that the software engineering involved with connecting to external devices and signals can be complex. These external devices and external signals may require precise timing when interacting with them; the use of specialized hardware and communication interfaces (for example, Direct Memory Access, PCI, CAN bus, Ethernet, etc.); specialized configuration interfaces; proprietary communications protocols (for example, ‘wire protocol’); hardware interfaces (for example, register based); custom error handling and fault recovery; specific startup or initialization procedures; etc.

One of the most important aspects of interfacing to external devices and signals is how the system communicates with the device. This is sometimes referred to as the “wire protocol.” This “wire protocol” consists of data that act as preamble, instructions, control or sensor data, and finally data that validates the accuracy of the message (e.g., cyclic redundancy check or CRC). Every device has a different way to combine and specify this data.

There are also a variety of ways the communications interface interacts with a computer system. Some of these are what is known as register based. The computer hardware can provide features that aid in preventing data loss or allow a wide range of configuration options to help with establishing reliable communications, allow degrading of communication transmission speeds to compensate for electrically noisy environments, etc. These registers have a wide variety of settings and configurations. Additionally, in many instances register based communication control exhibits state behavior and has important and sometimes complex workflow requirements, adding to the complexity of the development effort.

There are several “layers” of code that require development when external sensors and actuators are added to a system. For example, some of the code that is developed includes the code that controls and interacts with the communication's interface (discussed above); the code that interacts with application that needs to control or receive data from the external device; the code that takes the data from the application and converts it into data the external device can understand; the code that interfaces with the operating system in order be compliant with its programing interface architecture; etc.

In addition to writing software source code to meet the requirements of each of those layers, the code is created so that it can handle a wide range of communication requirements placed on it by the application. For example, some application code requires a notification indicating when data arrives (with possible varying levels of message completeness). Some application code will need multiple messages and data to be queued up until it is ready to read and process the data. Some will require a combination of both as well as other features.

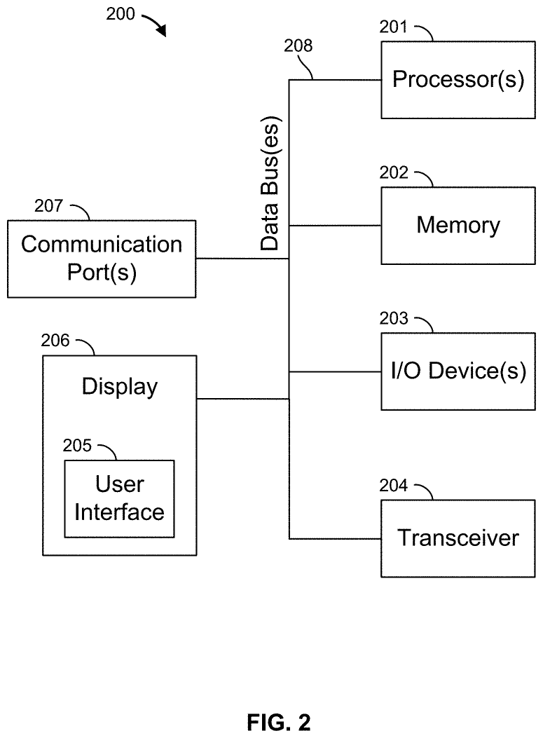

FIG. 2 illustrates an exemplary computing device 200 that can be employed by a disclosed system or used to execute a disclosed method. Computing device 200 can implement, for example, one or more of the functions described herein. It should be understood, however, that other computing device configurations are possible.

Computing device 200 can include one or more processors 201, memory 202, one or more input/output devices 203, a transceiver 204, one or more communication ports 207, and a display 206, all operatively coupled to one or more data buses 208. Data buses 208 allow for communication among the various devices. Data buses 208 can include wired, or wireless, communication channels. Data buses 208 are connected to one or more devices.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Memory 202 can include an instruction memory that can store instructions that can be accessed (e.g., read) and executed by processors 201. For example, the instruction memory can be a non-transitory, computer-readable storage medium such as a read-only memory (ROM), an electrically erasable programmable read-only memory (EEPROM), flash memory, a removable disk, CD-ROM, any non-volatile memory, or any other suitable memory. For example, the instruction memory can store instructions that, when executed by one or more processors 201, cause one or more processors 201 to perform one or more of the functions of an image reconstruction system.

Memory 202 can also include a working memory. Processors 201 can store data to, and read data from, the working memory. For example, processors 201 can store a working set of instructions to the working memory, such as instructions loaded from the instruction memory. Processors 201 can also use the working memory to store dynamic data created during the operation of computing device 200. The working memory can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 207 can include, for example, a serial port such as a universal asynchronous receiver/transmitter (UART) connection, a Universal Serial Bus (USB) connection, or any other suitable communication port or connection. In some examples, communication port(s) 207 allows for the programming of executable instructions in instruction memory 207. In some examples, communication port(s) 207 allow for the transfer (e.g., uploading or downloading) of data, such as sinograms (e.g., sinogram data 115).

Display 206 can display user interface 205. User interfaces 205 can enable user interaction with computing device 200. In some examples, a user can interact with user interface 205 by engaging input-output devices 203. In some examples, display 206 can be a touchscreen, where user interface 205 is displayed on the touchscreen.

Transceiver 204 can allow for communication with a network, such as a Wi-Fi network, an Ethernet network, a cellular network, or any other suitable communication network. For example, if operating in a cellular network, transceiver 204 is configured to allow communications with the cellular network. Processor(s) 201 is operable to receive data from, or send data to, a network via transceiver 204.

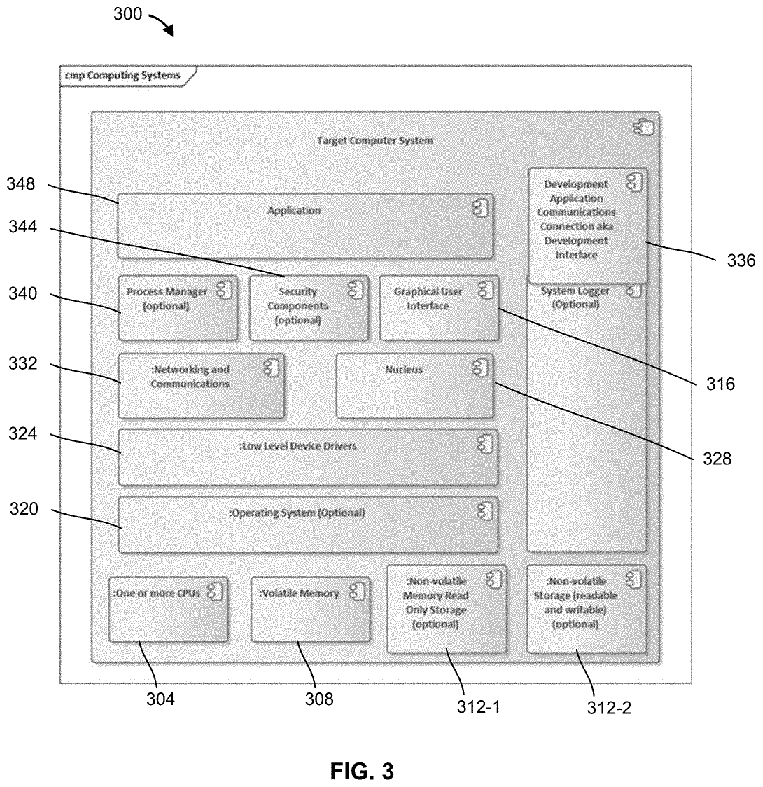

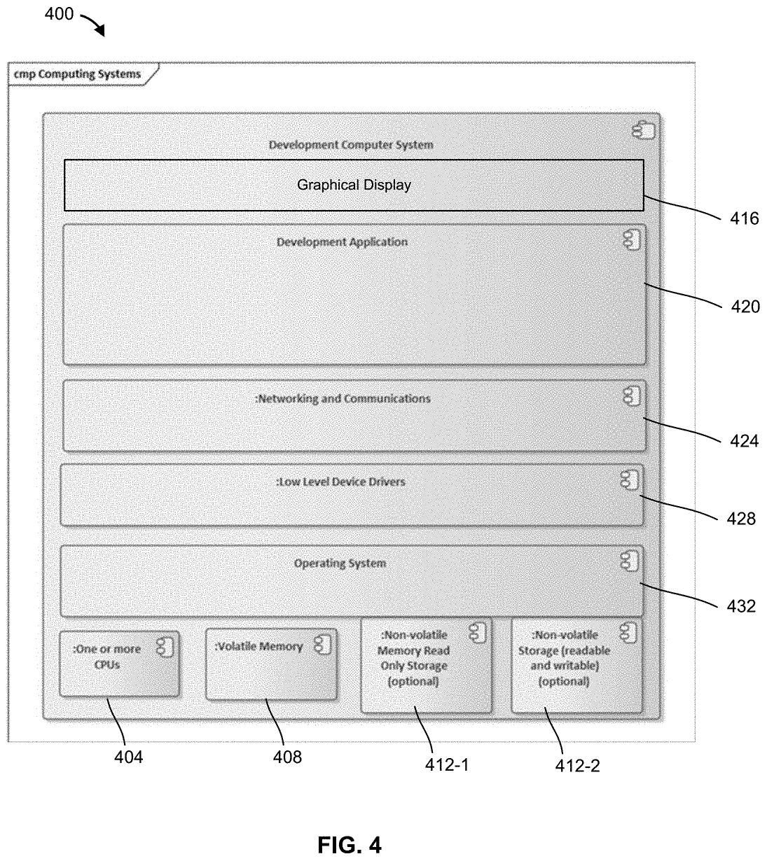

In various implementations, a development system according to the above-described systems may include a “target” computer system 300 of FIG. 3 and a “development” computer system 400 of FIG. 4. As shown in FIG. 3, the target computer system 300 may include one or more CPUs 304, random access memory 308, persistent storage 312-1, 312-2, and an optioSecuritnal text or graphical display 316.

According to an exemplary embodiment of FIG. 3, a disclosed system may store software that can include an optional operating system 320, optional low level device drivers for all peripherals 324, system to store arbitrary or structured data (for example, any of the memory listed above), a nucleus 328 (for example, a transparent network substrate as disclosed in U.S. Patent Application Publication No. 2016/0077813, herein incorporated by reference in its entirety), a networking and communications subcomponents 332, a communications to development system 336, an optional process manager 340, optional security components 344, an optional system logger 348, the optional graphical user interface 316, an optional configuration application (web or standalone) used to configure the system (the development application or interface), and an application 348.

The disclosed development systems can make it easy for a developer to connect external devices to the system's application 348.

Further, as shown in FIG. 4, the development computer system 400 may include one or more CPUs 404, random access memory 408, persistent storage 412-1, 412-2, a graphical display 416, a development application 420, networking and communications system 424, low level device drivers 428, and an operating system 432.

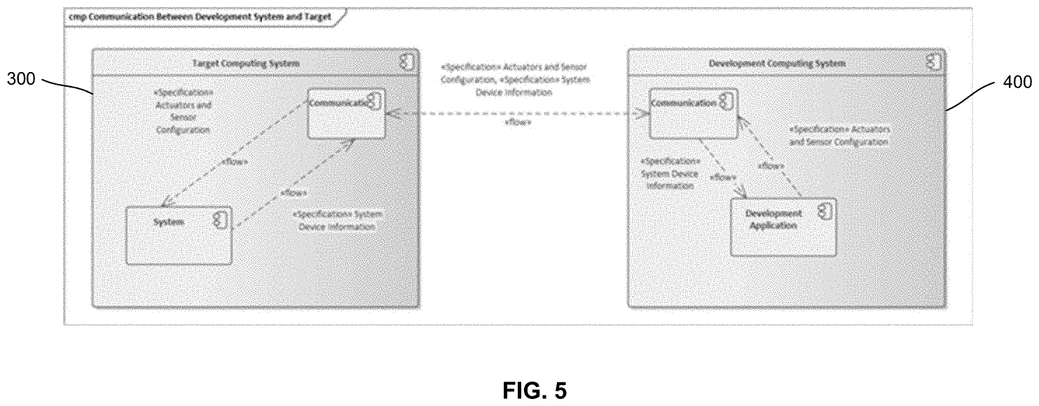

FIG. 5 includes a diagram of an exemplary system architecture of the described development system. More specifically, FIG. 5 depicts communication between the development computing system 400 and the target computing system 300.

The main parts of the DCAS (Dynamically Configurable Actuators and Sensors) system are structured and unstructured data storage (a.k.a., data storage); networking and communication subsystems; nucleus enabled software components; data storage interface software; code to interpret the information in data storage; sensor and actuator data structure; various data structures needed to process the information in data storage; and development application.

The target computing system 300 is loaded with the target components of the DCAS system (see Software components). Once these components are loaded onto the target computing system 300, the target computing system 300 becomes communicative with the development application 420 of the development computing system 400. The development application 420 can include a graphical user interface or a text based communications terminal interface used to configure the system, or it can be character/text based from a text editor.

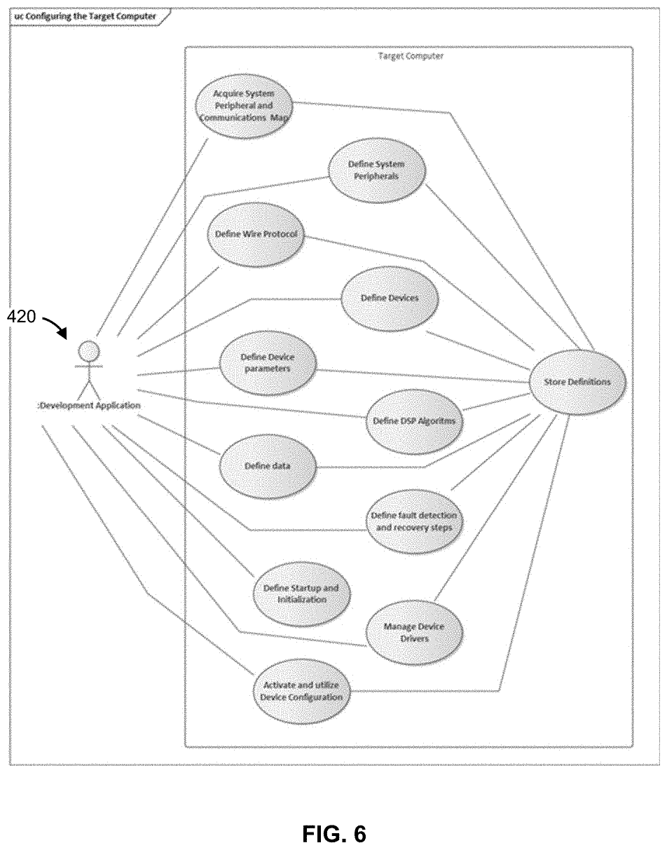

FIG. 6 includes a diagram showing an example of one or more processes that may be completed with respect to the target computing system 300 through the development interface. For example, the development application 420 utilizes the development interface to view the physical makeup of the target computing system 300 (for example, via a graphical user interface), such as the communications architecture of the target computing device, internal devices on the target computing device, etc.; define additional communications interfaces; load or unload low level communication device drivers; define the devices or signals to be integrated, along with the name and description; define the handshaking and protocol elements needed to establish and maintain communication; define the properties (configuration items) needed to control the behavior of the device; define the individual data by defining the name length and type of data; define how the system communicates with the device (timing, synchronicity, etc.); define any desired Digital Signal Processing to perform on the data to or from the device; define fault detection and recovery; define startup and initialization; etc.

The configuration is saved on the development computer and “pushed” onto the target device or the target computing system 300. Pushing the configuration means that the target stores the configuration into its structure and unstructured data storage device. Once the configuration is pushed to the device, the development application is able to enact and exercise communication with the external peripheral in order to test the configuration.

The following is a breakdown and description of an exemplary embodiment of a disclosed system and what resources it uses to perform its operations. The operations include Developer Interface; Peripheral Interrogation; Low Level Hardware Driver Interface Management; Communications Device Definition; External Device Definition; External Device Property Definition; Wire Protocol (a.k.a., Message) Definition; Message scheduling and notification Definition; Storage and Retrieval of Definitions; Message creation; Message transmission; Message reception; Message decomposition; Data Processing; Application Interface; and Data Delivery.

The developer interface is the interface between the Target Computer System (TCS) 300 and the Development Computer System (DCS) 400. The interface utilizes a dedicated communications line from the TCS 300 and listens for data from the DCS 400. This communications line can be any communications topology desired (e.g., serial port, Ethernet, wireless, etc.).

The developer interface uses industry standard means to transmit and receive data over the communications channel dedicated to the Interface. The data is encoded with a grammar known to both the TCS 300 and DCS 400. This encoding could follow an industry standard encoding protocol (e.g., XML, J1939, CanOpen, etc.) or it can be a custom encoding created by the manufacturer.

The TCS 300 defines the developer interface. The CPU on the TCS 300 is used to interpret the message data arriving over the communication line from the DCS 400 and perform the requested operations.

The developer interface recognizes a variety of commands. For example, the developer interface recognizes an interrogate command. The interrogate command retrieves information about the TCS 300 and its architecture. Additionally, the interrogate command can be commanded to return a partial list or a full list of the following number of CPUs; communication buses; known external devices; low level device drivers that are active; unstructured data storage devices; structured data storage devices; processes running; communication bus types; exported class, class methods and variables from active (running) processes; etc. The developer interface also recognizes a start low level driver command, which also includes the parameters the driver should use. The low level driver parameters are passed to the TCS 300 as individual elements and are based on the documentation of the low level driver.

The developer interface also recognizes a stop low level driver command, which causes a low level driver to stop functioning. The developer interface also recognizes commands corresponding to data. These commands include write data, read data, and capture data. The write data command writes data to a communication bus or register. The write data command includes destination type (communication bus or register), the name or address of the bus or register, and finally the data that is desired to be sent to the bus or register. The read data command reads data a communication bus, a register, or a data capture request. The read data command includes the same information as above except that it will return the data it receives. If a data capture request is desired, then the name of a previously setup capture data request is provided. The capture data command sets up an event driven capture of data from a communications bus or register. To setup a capture data request, the same information as provided for a read data command or request is included. A name is also provided so the capture data request can be retrieved later.

The developer interface also recognizes a define communications bus command, which associates a low level driver with a named communication bus; defines the type of bus (types are defined/enumerated by the developer interface); defines an optional global wire protocol (message) structure for the bus (for example, CAN bus message); defines any global commands for the communications bus; and defines the communication bus settings (duplex, speed, any electrical signal parameters, etc.). The developer interface also recognizes a define external device command, which associates a named communications bus with a named external device; defines the properties supported by the device; defines the wire protocol (message structure) for the device (can inherit from the Communications bus definition); defines the commands for the device and associates with its properties; and defines how to translate property set/get requests into the defined message structure (depending on the number of properties to set or retrieve, multiple messages may need to be created).

The developer interface also recognizes a write property command, which causes the TCS 300 to use the defined wire protocol for an external device to write data associated with a device's predefined property. The write property command includes the name of the external device, the name of the property, and the value. The developer interface also recognizes a read property command, which causes the TCS 300 to use the defined wire protocol for an external device to read data associated with a device's predefined property. The read property command includes the name of the external device and the name of the property and the value is returned. The developer interface also recognizes a retrieve log information command, which causes the TCS 300 to return log data. The retrieve log information command is a useful tool to understand why something succeeded or failed. The developer can provide filters to restrict the data returned. The filters can include data, time, subsystem, external device, communication bus, and a search string. The developer interface can further recognize commands that create instances of exported classes, invoke methods on class instances, invoke exported functions, read and write directly to exported variables, etc.

In various implementations, the developer has a TCS, such as TCS 300 in FIG. 3, with a disclosed software configuration installed, and the developer has connected one or more sensors or actuators to the TCS 300 via some communications bus. Through the developer interface, the developer may issue an “Interrogate” command in order to learn what the TCS 300 knows about itself. The TCS 300 responds with a list of items it knows about. It may or may not know about the communications bus to which the developer has attached one or more sensors or actuators. If the communications bus to which the sensors or actuators are connected is not listed, the developer issues the command to start the low level driver for the communications bus including settings necessary for the low level driver to setup the correct communications bus.

The TCS 300, upon receiving the above command, initiates the low level driver specified. The TCS 300 ensures the driver starts and runs and returns a notification through the developer interface informing the developer whether or not the driver succeeded in starting up. The developer may then issues a command to define a communications bus and associates the newly started driver with the communications bus. A name is also provided to name the bus. The developer also specifies the remaining items under described with the define communications bus command above as required. The TCS 300 may receive the define communication bus command and stores the association in persistent storage (structured or unstructured memory). The TCS 300 returns a notification through the developer interface telling the developer whether or not the request succeeded. The developer may now define the external device (an actuator or sensor). The developer does so and provides the information listed under the define external device command. The developer can now test the external device using the read or write property command.

In order to transfer data to and from properties, messages being sent to the external device must be constructed. While other systems have the messages to devices pre-programmed into the software, the developer system described herein can allow the messages to be constructed dynamically based on a message description, providing a novel and unique solution to standard, pre-programmed software. Regarding message construction, the developer system is instructing the computer how to communicate with the external device. The messages are typically made up of a header, a body, and error correction data. The structure of the header, body and error correction data are described by the use of Message Elements that consist of data items or message elements. Message Elements describe the type and length of the data contained by the header, body or error correction data. Structuring the data in this way provides self-referencing and reporting capabilities that reduce confusion when constructing messages and so that data from the device can be verified.

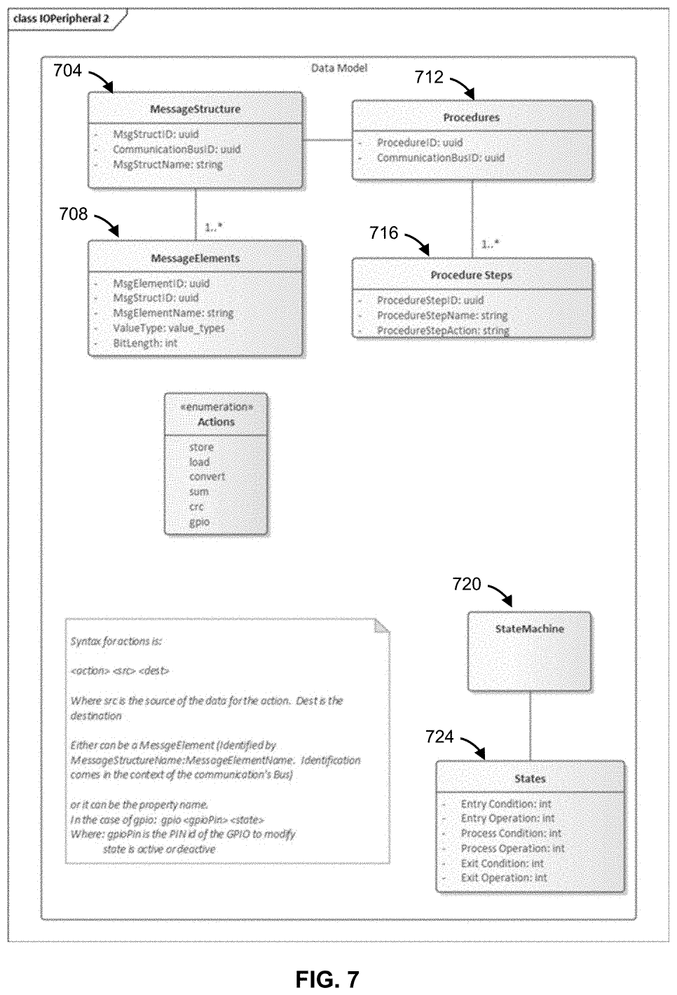

FIG. 7 is an Entity Relationship diagram describing the parts of a wire protocol definition. Message Structures 704 and their associated Message Elements 708 define the organization of the message to and from the peripheral. Each message structure is unique in the context of a defined external device. A device's message structure only needs to be defined once even if there are multiple instances of the same device on the communications bus. Procedures 712 and their associated Procedure Steps 716 define how to construct and deconstruct a message.

The procedure steps 716 define the actual steps of placing and retrieving data in a message, constructing the message header, and validating message accuracy.

A state machine 720 and the state machine's states 724 provide a mechanism for data communication sequencing. For example, if messages are interpreted based on external device state behavior, this allows that state behavior to be defined and how to construct the message based on that state.

The procedures 712 have some standard instructions they can invoke. They are create message and update message. Create message starts a new message and parameters include message element identifiers and data to store in the message. Update message is used if there are multiple commands put into a single message. Update message also takes parameters of message element identifiers and data to store into the message.

Properties are the data the external device provides or consumes. For example, a motor controller may have a property for a desired rotational speed of the motor. This value is consumed by the motor controller and when set, causes the motor controller to rotate the motor at the specified speed or position. A sensor may have a property that defines the sensed value. These properties are described by the developer using the development interface when an external device is defined.

Along with properties, commands provide a means to instruct an external device to provide or consume a property. In other words, properties are the data and commands are then instructions to the external device on what to do with the data. The developer is responsible for informing the TCS 300 of these properties and commands. The wire protocol and the procedures within the wire protocol definition instruct the TCS 300 how to issue a command to set or retrieve properties.

When it is time to send or receive a property or properties to or from an external device a message has to be assembled instructing the external device to accept some data, reply with some data or both. When this time arrives, one or more properties are queued for transmission. The system or software iterates through the queued properties. The property references a command, and the referenced command is queried. The command is used to find the procedure, and the procedure is executed in the context of any required state behavior. This causes a message to be created or if the message was created in the previous iteration, it is updated with message data. Once one or more messages are created, they are then sent.

When a message arrives from an external device, the procedure for message reception is invoked. This procedure will direct the system to read various parts of the message to determine its content and ultimately where the data is stored. The reception procedure may use the header information to determine the type of message, and branching to other procedures. As procedures reference message elements, it is the message element that determines the position in the message stream to read.

The first operation of the procedure is to determine the message is valid. Then, the procedure will determine where in the message to read information to determine the next steps. Procedures can link to each other so they can be run as a sequence. Once the procedure has retrieved information to determine what data has arrived, it uses that data to do a lookup in the command table for the device to determine which property is to receive the data. The procedure then updates the parameter. The action of updating the parameter will cause notifications to be sent indicating newly arrived data.

Devices are connected to communication interfaces. Devices have the following attributes: device identifier; manufacturer; model number; serial number or other identifier that will allow it to be unique on the communication bus; and description, which is optional. Using the developer interface, the developer can create instances of devices. Devices must be identified uniquely in the system. To facilitate clear understanding of the devices that are connected and to facilitate the system's documentation and configuration management requirements the system also tracks Manufacturers, device model numbers and serial number.

The developer can create the list of Manufacturers using the developer interface, and it can then create device part numbers, associating the Manufacturer with the device part to uniquely identify the device. Finally, the developer, using the developer interface, creates device instances, associating the device model with that particular instance of the device. The device instance is also associated with a communications bus. A device instance can be associated with more than one communication bus, which supports the case for redundancy. The developer interface can also be used to specify a rule set for failover and recovery.

Devices have a predefined message and data transfer semantics. This is commonly referred to as a “protocol.” The manufacturer designs and builds this protocol into the device. Sometimes these protocols are based on industry standards, sometimes they are custom to the manufacturer. The goal of this configuration is to provide the information necessary for the system to communicate with the device. Sometimes properties can only be associated with one message. Sometimes multiple properties can be put into a single message. In either case, a parameter has specific data used to set or request it. This information is sorted as Wire Parameter Definition. This Definition contains the parameter identifier of the parameter, the constant data payload, and the variable data payload. These payloads are defined using Data Items (See Data Item, above). The developer interface is used to create a new parameter along with its name, the data items and values used to command the device to set or retrieve the parameter, and other parameter attributes. It also defines the data items used to send or retrieve the actual data.

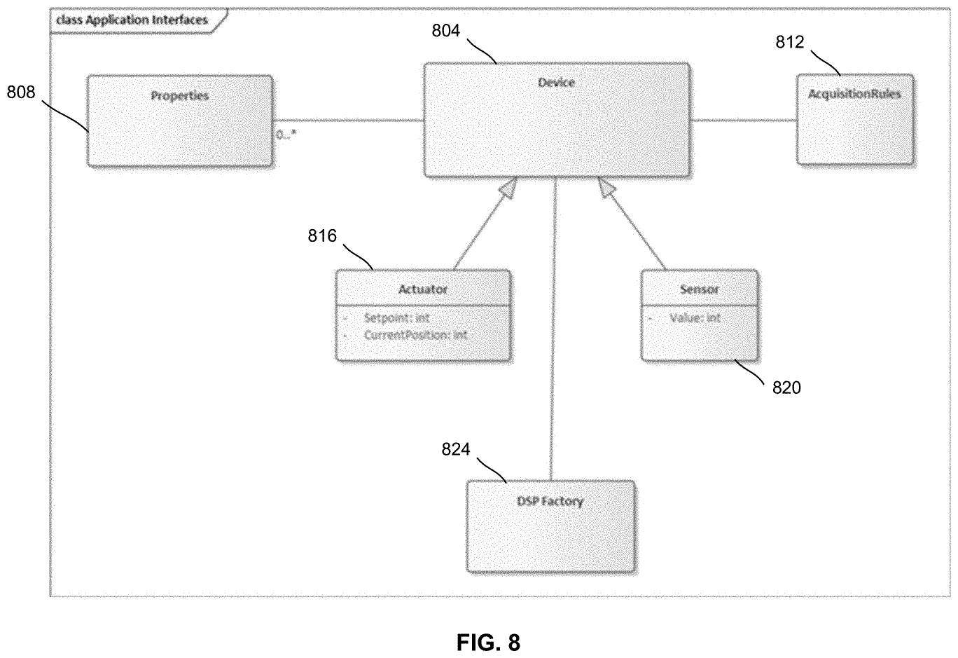

FIG. 8 includes a diagram of an example data structure of application interfaces, depicting a device 804, properties 808, acquisition rules 812, an actuator 816, a sensor 820, and a DSP factory 824. The depicted functional groups, along with the actuator 816 and sensor 820 interfaces are given below in generic object oriented pseudo code.

The DCAS system provides the programmer with two interfaces, the actuator 816 and the sensor 820. These interfaces are generic in that they can accommodate any external actuator or sensor. These interfaces build upon other functional groups to provide organization and processing capability to the actuator 816 and sensor 820 interfaces.

The basic interface for actuators and sensors is the Device 804. In order to make the actuator 816 and sensor 820 generic enough to handle any external peripheral, the Device 804 incorporates the concept of properties 808. Properties 808 are a data type that can associate an identifier (typically a string) with a datum defined by the device being communicated with. Most devices are constructed with the ability to have multiple values that define properties of a device. These properties 808 might include such things as a serial number, positional values, calibration values, actuator temperature, sensor values, etc. These properties might be bidirectional. For example, properties 80 may be written to a motor control to position the motor while the same value may be read back in order to read the most recent set point. Properties 808 in the software development kit represent the attributes of a device.

Properties 808 are defined by the person introducing the device into the system. These properties can be found from the device's user manual where the information on how to communicate with the device are found. Properties 808 may include a name, a value, the data required to command the device to set or retrieve the parameter, time stamp of the last time the value was modified (either read from the device or updated via the application software), and a second time stamp for data that was written. The properties 808 can also include a rule set to govern when the parameter is retrieved or written to the device, a reference to the field of a data structure that is to be updated with the parameter when read or used to retrieve a value that is to be written to the device, and a list of entities that need to be notified when the property changes. The actuator 816 has two members that are mapped to a device's properties. These members are the SetPoint and the CurrentPosition. Mapping these members to these specific properties allows auto update of these members when new data arrives. The sensor 820 has one member, Value, that is mapped to a Device's properties.

Triggers are used to send messages to the device 804. A Trigger can cause one or more messages to be sent. Triggers may include an identifier and a name, a source, and message definition identifiers that are handled when the trigger is triggered. The source can be one of many definitions, such as manual, based on a hardware event or interrupt, timer based, and condition based. Triggers are defined much the same way other items (message definitions, properties, devices, etc.) using the developer interface.

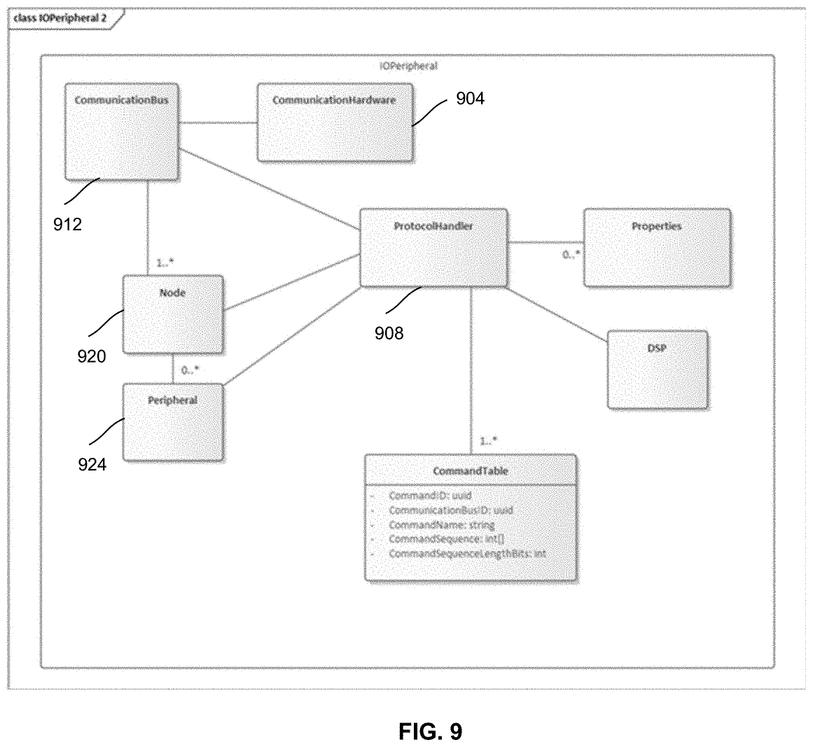

FIG. 9 is a diagram of the structure of the part of the system that handles communication with devices, such as peripherals. When data arrives, it is passed through the Communication's Bus Hardware 904 component. Hardware then moves the data into the CommunicationsBus::Protocol Handler 908 via the CommunicationsBus 912. From there, it moves into the Node::ProtocolHandler 916 and finally into the Peripheral:: Protocol Handler 920. The data usually arrives in pieces. As data arrives, it is added to the previous data and all ProtocolHandlers are given a chance to read and process the data.

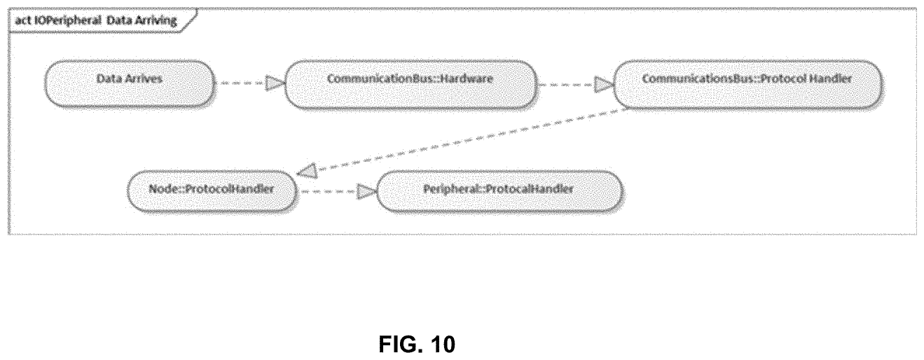

FIG. 10 is a flow diagram depicting data arriving. As data in the message is recognized, the data is moved into the respective properties. Whenever the high level application changes data that is to be sent, the proxy objects in the high level application send it to this system. The data is then sent to the device based on the trigger setup. If the trigger is ‘manual’, the data is immediately sent, otherwise the conditions specified for the trigger are used to determine when the data is sent to the device. A benefit of the disclosed embodiments is an ability to adapt any external device to the TCS 300 without software development. Another exemplary benefit is an ability to refer to a device by name and instance name in a high level application.

The development application communicates with the target in real time and allows the user to create communication packets to the various devices. Using the feedback from those manual communication attempts, the user creates configurations that can be invoked and utilized by application software. These configurations are saved to the target's structured and unstructured data storage.

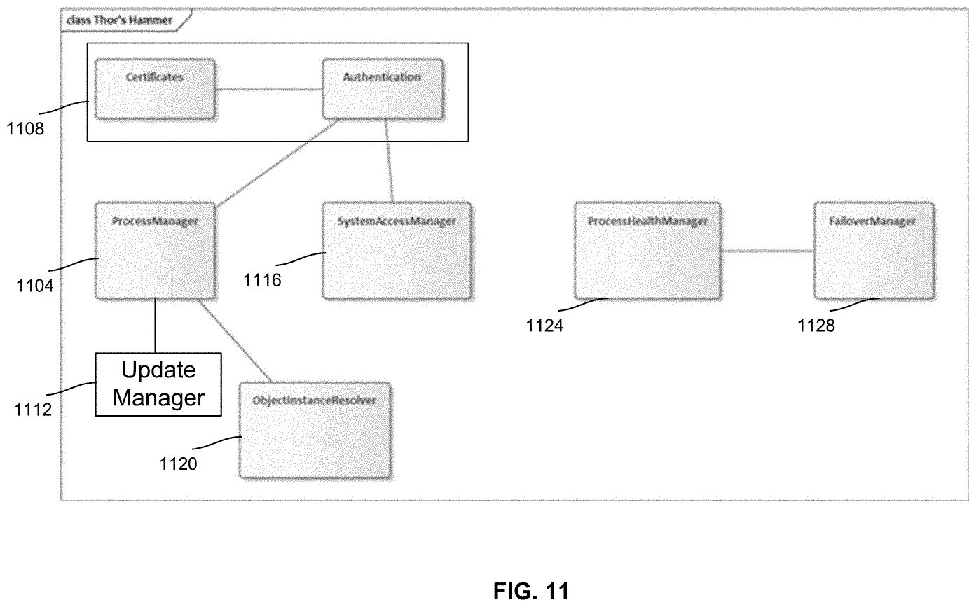

FIG. 11 is a diagram of an exemplary embodiment of a process manager. In an exemplary embodiment, the Process Manager is made up of seven modules, including a process manager module 1104, a certificate, encryption and authentication manager 1108, an update manager 1112, a system access manager 1116, an object instance resolver 1120, a process health monitor 1124, and a failover/recover manager 1128.

The Process Manager 1104 can include a process manager module configured to read lists of binaries that are required to be operational. There is a list for each configuration of the system. For example, if the system has different ‘runlevels’, there is a list for each runlevel. The Process Manager Module determines which list is required and causes the binaries in that list to run. These binary lists are stored in structured or unstructured persistent storage. Because there may be binaries common to each list, the Process Manager Module, when switching between lists, will start and stop only the processes that differ between lists. The Process Manager Module can be constructed so that it is able to see what processes are running. This view is obtained by using the Operating System's API on a periodic basis or from a notification that comes from the Operating System. If there are binaries that are running that are not in the active list, the binary is removed. There is a list entry that allows binaries to run, but are not started by the Process Manager Module

The Process Manager Module can be further constructed so that it can read certificate and message digest (hash) information. Certificates for the binaries can be linked with the binary or can reside as a separate file. The certificate contains the digital signature of the binary along with a message digest (hash) of the binary and certificate itself. The Process Manager Module does the following to authenticate the binary (using the Certificate, Encryption and Authentication Manager 1108): determines where each process' binary is stored in persistent storage; reads the certificate, from either a separate file or the binary itself (implementation dependent); determines if the certificate is valid; determines if the binary is correctly signed; determines if the message digest in the certificate matches the message digest of the binary; determines if the binary is authorized; queries the binary via Inter Process Communication (IPC) to retrieve the certificate and signature from the running process; compares the certificate with the certificate read from the binary; and reads the binary section information and CRC's the code section while the binary is running and compares it to the CRC of the binary in persistent storage.

If any of the above tests fail, the binary is removed from memory and the system is put into a faulted state and made inoperative. The authentication capability determines whether or not the binary is authorized before the Process Manager Module runs the binary. It also determines whether or not binaries that are not started by the Process Manager Module are authorized if they are running.

The Process Manager 1104 can be constructed so that it can work with certificates via a certificate manager. The certificate manager (Certificate, Encryption and Authentication Manager 1108) can, for example verify certificate authenticity, read certificate metadata, validate digital signatures, calculate message digests, create certificates, use or create One Time Password key exchange and synchronization, Message Authentication Code and Key Hash Message Authentication Code generation and validation, and/or handle user password management.

The Process Manager 1104 can also be constructed so that it can do several encryption related tasks via an encryption manager, including, for example, asymmetric and symmetric key generation, external public key verification, TLS version 1.3, asymmetric and symmetric encryption and decryption, message digest calculation, and/or use hardware acceleration for cryptographic activities.

The Process Manager 1104 can also constructed so that it can authenticate users, binaries and capabilities with an authentication manager. The authentication manager (Certificate, Encryption and Authentication Manager 1108) can be constructed to allow different access levels on a per user basis. These access levels are predefined by the implementer of the Process Manager 1104. These access levels can control the binaries that can be run on the system, the features of the system the user has permission to use, and access to data.

The Process Manager 1104 does not predefine the levels of access, nor does it predefine the relationship between features and access levels. This is defined by the developers implementing this access control. The Process Manager 1104 has a very generic feature and access level matrix that is populated by the developers of the system. The date types used in this list are guaranteed to be compatible with the metadata section of certificates. The developers specify a name and a unique value for the specific set of features they want to control. Then if the user's certificate permission section of the metadata contains this value, when a system component performs a query, the query results in the affirmative.

The Process Manager 1104 will also validate users that wish to access the system. The Process Manager 1104 is capable of doing multi-factor authentication. The Process Manager can manage users' passwords, including password creation, reset and validation. It also utilizes intrusion protection algorithms to limit access to validation routines if multiple failures to authenticate are detected.

As with users, the authentication manager (Certificate, Encryption and Authentication Manager 1108) can enforce access controls on binaries. The Process Manager 1104 provides the ability to read the metadata in a binary's certificate enabling the ability to determine what privileges the binary should be granted. The authentication manager (Certificate, Encryption and Authentication Manager 1108) can also control what features and capabilities are enabled by the system. A certificate for the system can be installed and read by the Process Manager 1104 to determine what functionality is ‘turned on’ when the system starts up. Just as with user privilege levels, none of these capabilities are predefined in the Process Manager 1104. Instead, the Process Manager 1104 provides a matrix allowing the developer to name and map features to unique identifiers generically. These identifiers can then either be included into the certificate for the system or combined into a human readable license key. The Process Manager 1104 provides an external interface so that other processes may query for capability information.

The Process Manager 1104 can be constructed to manage updates from the manufacturer by the update manager 1112. The update is digitally signed and optionally encrypted. Each component of the update is also digitally signed. This is so that post installation checks can see that files installed onto the system match the original update.

The update may include digitally signed Certificate attesting to the origin, version and date of the update; a manifest containing the contents of the update and the destination to where the contents need to be written; the manifest will also contain post installation tasks that the Process Manager 1104 will execute; file movement occurs into a new area of persistent storage, once the files have been copied, a single command switches the old installation with the new installation; the old installation is preserved; the installation certificate is also installed; many installations can coexist on the same system, and the update manager 1112 can switch between installations, providing the ability to roll back in case of a failed installation; and when installing to the new installation location, the manifest will list files that need to be copied from the previous installation to the new, which preserves collected data.

The Process Manager 1104 using user authentication can grant access to various levels of the system as defined by the developer using the system access manager 1116. For example, a technician that needs access to ssh for command line, the technician can use a key card, multi-factor authentication, or just a username and password. It is all dependent on how the developer sets it up.

The Process Manager 1104 is in total control over listening TCP/IP ports and physical input devices. Only those networking and human machine interfaces are active that are necessary during normal operation. When additional access is required for servicing, troubleshooting or auditing, the Process Manager 1104 will allow it. These levels of access are controlled the same way user access or binary access is controlled.

The Process Manager 1104 is also responsible for directing client applications to the servers that have the functionality desired, such as through the object instance resolver 1120. When servers start and are ready to accept connections, they send an IPC message to the Process Manager 1104 to register the functionality in the server. An example of this would be a motor that moved a left arm. The server will register the identifying data with the Process Manager 1104. A client on the other hand, when it wants to access the left arm, will send a message to the Process Manager 1104 asking for an instance of the object that controls the left arm. The Process Manager 1104 will redirect the client to the server that has registered this functionality. This supports the global identification of system functionality, allowing clients to access key features without hard coding software dependencies. It also brings the simplicity of having all functionality in a multi thread single process to the multi-process, thread pool model.

The Process Manager 1104 can also include the process health monitor 1124. Each process running in the system will be described in the binary list the Process Manager 1104 uses to manage the processes. Part of the description will be a set of metrics to use that identify a healthy process. If any of those metrics are violated, the Process Manager 1104 will execute a recovery/failover specification.

To monitor the health, the binary being monitored will export a common interface (common to all processes). The Process Manager 1104 will set up to receive events both from the binary and from the operating system that will notify it of an exception. Also, the Process Manager 1104 will query on a regular basis various Operating System statistics on the process as well as statistic internal to the process. The developer will specify what those statistics are and normal ranges for their values. The statistics will be identified by string name so that the Process Manager 1104 can have a generic interface that is applicable to any process.

The Process Manager 1104 can also include a Failover/Recover manager 1128. As part of the metrics specified for the binary, a recovery procedure is also specified. The Process Manager 1104 allows multiple recovery procedures per binary. Each is invoked based on statistical results from the performance metrics defined for the binary. For example, if a process is using more than a certain percentage on a specific CPU, the binary entry instructs the Process Manager 1104 to remove the process from memory and restart it. All processes in the system will then receive notification that the binary was removed from memory if they were involved with that process. They will have the necessary code to release resources and reconnect when it is restarted.

The recovery may include rollover. In this case, the process is restarted with command line parameters that indicate it is second in line to the process that was on standby. The process that was on standby is notified that is the primary source. In those situations, the standby process will have duplicated all of that the primary process was doing and will be able to pick up where the primary left off.

Typically, security in a purpose built computing system is ad-hoc. Also, management of what is running on the system is done using simple startup scripts with no control over the process after it has been started. Usually a purpose built system will not have any monitoring of process or system health. If it does, it will be very specific to that process and will be hard coded. If a process wants to do encrypted communications, it and of itself is responsible. There is no existing centralized control of processes that includes the above-mentioned capabilities. By including all of the above functions together, and by making the operation of the process manager based on data from either structured or unstructured persistent storage, and certificates the developer can easily build a wall of protection around their purpose built system by simply updating this persistent storage with the information described above. Because this Process Manager 1104 already controls the state of each process of the system, it can also standardize the health monitoring, failover/recovery and manage access.

While other systems will contain one or more of these features, no other system combines all of these features into a single system, and integrates these features in a way that they support each other in the manager described above. By doing so, developers can make their systems more reliable and more secure without having to write custom software to do so. Further, the developer does not have to build in security related features into individual processes.

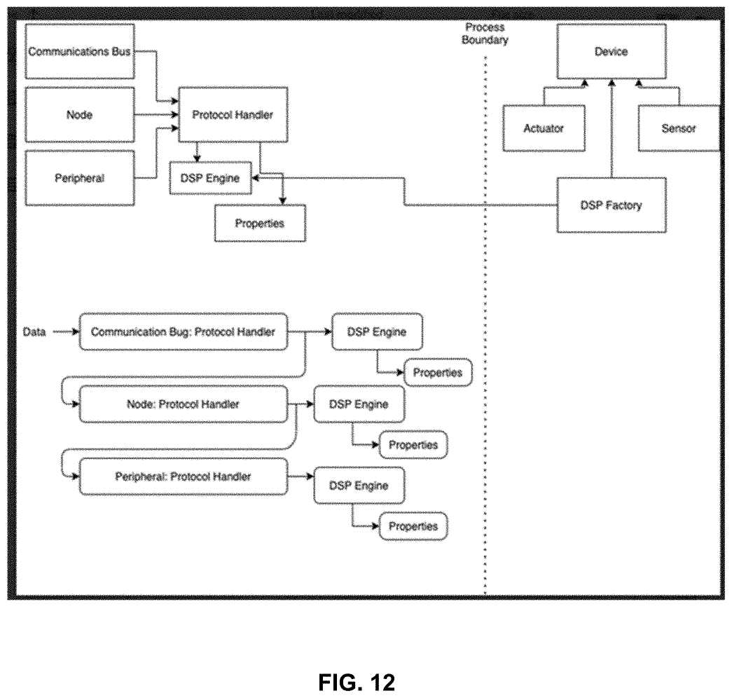

FIG. 12 is a diagram of an exemplary digital signal processing system. Disclosed embodiments relate to dynamic digital signal processing (DSP). Embedded computing systems, especially those that control machinery and/or collect and report on signals do some sort of Digital Signal Processing (DSP). Typically this processing occurs when data is gathered from sensors. High level applications will put this data through algorithms in order to clean up, scale or otherwise refine the data. Typically these algorithms are hand coded or generated by software that helps simulate and develop signal processing signal processing applications. This code is then inserted into specific places in the software being developed for the embedded system.

The drawbacks with this work flow are many, including: the algorithms are hard coded and require a software update in order to change the algorithm, meaning the algorithms cannot be adjusted or modified while the system is running; simulation software has limitations because it typically is not working with live data from the embedded systems, resulting in developers spending too much time on information that is not representative of the real system and making incorrect decisions in the production system; sometimes it is learned that data process algorithms need to be added or moved to different parts of the data flow in the system, requiring significant changes to the system; since new idea and algorithm introduction is so costly, the end product may not function as well as it could; and if a system under development for production is being used to characterize input signals and subsequent output has been wired (via hardware and software) to see live signals during development, significant changes to the software and hardware are needed to bring the system into a state where it can be released for production.

For example, disclosed embodiments may relate to a communication between a computing device and an external device such as a sensor or actuator. The computing device may be configured to use disclosed methods to interact with the external device and interpret signals received therefrom. The disclosed embodiments may be applicable to a dynamically configurable computing system that includes an application for allowing a developer to adapt the computing system to communicate with and understand the external device.

Disclosed embodiments can allow the creation of algorithms and placement in a system's data flow without updating the software on the system. It also allows developers to place algorithms at any point along the path of data flow in the system without modifying the software.

Additionally, disclosed embodiments can allow arbitrary data capture at any point along the path of data flow. It also provides means to offload that data over a communications bus or data storage system without interfering with the overall system's timing requirements.

Once configured with the algorithm and the point along the data path the processing occurs, the algorithm can be made permanent, without rebuilding any of the binaries on the system. The system includes, for example, a two way communications channel, a computer programming compiler/linker or interpreter on the target, and a remote procedure call interface used to connect the data path for sensor and actuator data. The system can be used remotely via the two way communications channel, or it can be used directly by software. If the two way communications channel is used, the developer can access and modify input and output of a live system.

If it is used by software, it allows high level application software to do high speed digital signal processing at the source of the data. This might be needed if the application software has no control over how the data acquisition is implemented in a system, for example in a multi-process environment where the data acquisition portion of the system is fixed.

In this case, the developers can insert DSP algorithms at any point in the data acquisition portion of the system without having to change this part of the system. To use the Differentiable Digital Signal Processing (“DDSP”) framework a developer does the following. The first step is to include the DDSP framework into the embedded system. This is done by inserting the DDSP framework in between each point in the system where data is acquired, moved or transmitted. Once the DDSP framework is installed into the embedded system, a developer can now insert algorithms along the data path. This is done in one of two ways: using the communications channel and/or via an internal application interface (API).

To use the system remotely via the two way communications channel the developer may connect to the DDSP communication's channel; issue the command to retrieve the data map; the DDSP subsystem queries the embedded system and creates a data map; the DDSP subsystem returns the data map over the communications channel; the developer selects the data transfer point that needs processing; the developer creates a message containing Data Transfer Point ID and source code in the chosen language expressing the algorithm; the developer uploads the message to DDSP; DDSP receives the code from the developer, uses the installed language compiler and linker (creating a shared library) and installs it on the data transfer point; and, if there are no errors, the code is activated and a success notification is returned to the client. At this point the algorithm is run each time one or more pieces of data is passed through the data transfer point.

The apparatuses and processes are not limited to the specific embodiments described herein. In addition, components of each apparatus and each process can be practiced independent and separate from other components and processes described herein.

The previous description of embodiments is provided to enable any person skilled in the art to practice the disclosure. The various modifications to these embodiments will be readily apparent to those skilled in the art, and the generic principles defined herein can be applied to other embodiments without the use of inventive faculty. The present disclosure is not intended to be limited to the embodiments shown herein, but is to be accorded the widest scope consistent with the principles and novel features disclosed herein.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A computer-implemented method, comprising:
connecting a target system to a development system via an application;
connecting an external device to an interface of the target system;
obtaining information about the target system and transmitting the information to the development system;
instructing initiation of a driver associated with the interface based on a command received from the development system;
receiving a command to define and store a communications bus associated with the driver from the development system;
receiving information about the external device from the development system; and
associating the information about the external device with the communications bus.

2. The computer-implemented method of claim 1, further comprising using the information to generate messages at runtime to communicate with the external device.

3. The computer-implemented method of claim 2, wherein the generated messages include a header, a body, and error correction data, and wherein the header, the body, and the error correction data are described by message elements including data items describing a type and a length of the data contained by the header, the body, or the error correction data.

4. The computer-implemented method of claim 1, further comprising testing the external device based on a command received from the development system.

5. The computer-implemented method of claim 1, wherein the external device is an actuator.

6. The computer-implemented method of claim 1, wherein the external device is a sensor.

7. The computer-implemented method of claim 1, further comprising, in response to receiving an interrogate command, transmitting a set of information indicating a set of external devices connected to the target system.

8. The computer-implemented method of claim 1, further comprising, in response to receiving a define communications bus command, associating a low level driver with an identified communication bus.

9. A system comprising:
a development system;
a target system configured to connect to the development system via an application; and
an external device configured to connect to an interface of the target system;
the development system being configured to:
obtain information about the target system;
transmit a command instructing an initiation of a driver associated with the interface;
transmit a command to define and store a communications bus associated with the driver;
transmit information about the external device; and
associate the information about the external device with the communications bus.

10. The system of claim 9, wherein the development system is further configured to use the information to generate messages at runtime to communicate with the external device.

11. The system of claim 10, wherein the generated messages include a header, a body, and error correction data, and wherein the header, the body, and the error correction data are described by message elements including data items describing a type and a length of the data contained by the header, the body, or the error correction data.

12. The system of claim 9, wherein the external device is tested based on a command received from the development system.

13. The system of claim 9, wherein the external device is an actuator.

14. The system of claim 9, wherein the external device is a sensor.

15. The system of claim 9, wherein the development system is further configured to, in response to receiving an interrogate command, transmitting a set of information indicating a set of external devices connected to the target system.

16. The system of claim 9, wherein the development system is further configured to, in response to receiving a define communications bus command, associating a low level driver with an identified communication bus.

17. A non-transitory computer readable medium having instructions stored thereon, wherein the instructions, when executed by at least one processor, cause a device to perform operations comprising:
connecting a target system to a development system via an application;
connecting an external device to an interface of the target system;
obtaining information about the target system and transmitting the information to the development system;
instructing initiation of a driver associated with the interface based on a command received from the development system;
receiving a command to define and store a communications bus associated with the driver from the development system;
receiving information about the external device from the development system; and
associating the information about the external device with the communications bus.

18. The non-transitory computer readable medium of claim 17, wherein the instructions include using the information to generate messages at runtime to communicate with the external device.

19. The non-transitory computer readable medium of claim 18, wherein the generated messages include a header, a body, and error correction data, and wherein the header, the body, and the error correction data are described by message elements including data items describing a type and a length of the data contained by the header, the body, or the error correction data.

20. The non-transitory computer readable medium of claim 17, wherein the instructions include testing the external device based on a command received from the development system.
